(19) United States
(12) Patent Application Publication
(10) Pub. No.: US 2018/0349568 A1
(43) Pub. Date: Dec. 6, 2018

(54) AUGMENTED REALITY SYSTEM AND METHOD

(71) Applicant: Hookline Inc., New York, NY (US)

(72) Inventors: LAURA S. SCHECHTER, Westport, CT (US); Patrick Manasse, New York, NY (US); Ron Zakay, San Francisco, CA (US)

(21) Appl. No.: 15/995,696

(22) Filed: Jun. 1, 2018

Related U.S. Application Data
(60) Provisional application No. 62/513,686, filed on Jun. 1, 2017.
(60) Provisional application No. 62/527,364, filed on Jun. 30, 2017.
(60) Provisional application No. 62/559,953, filed on Sep. 18, 2017.

(51) Int. Cl. G06F 21/10; G06K 9/00; G06T 19/00; G06F 17/30

(52) U.S. Cl. CPC G06F 21/10; G06F 17/30277; G06T 19/006; G06K 9/00671

(57) ABSTRACT

A computer-implemented method, computer program product and computing system for defining a plurality of augmented reality objects. Ownership rights are associated with one or more of the plurality of augmented reality objects. A user is enabled to query the plurality of augmented reality objects within an accessible virtual space to identify a specific augmented reality object.

### RELATED APPLICATION(S)

This application claims the benefit of the following U.S. Provisional Application Nos. 62/513,686, filed on 1 Jun. 2017; 62/527,364, filed on 30 Jun. 2017; and 62/559,953, filed on 18 Sep. 2017; their entire contents of which are incorporated herein by reference.

### TECHNICAL FIELD

This disclosure relates to augmented reality platforms and, more particularly, to augmented reality platforms that allow content to be associated with AR objects.

### BACKGROUND

As is known in the art, augmented reality (AR) is a direct or indirect live view of a physical, real-world environment wherein elements are “augmented” by computer-generated perceptual information, ideally across multiple sensory modalities (e.g., visual, auditory, haptic, somatosensory, and olfactory). The overlaid sensory information may be constructive (i.e. additive to the natural environment) or destructive (i.e. masking of the natural environment) and may be spatially registered with the physical world such that the overlaid sensory information may be perceived as an immersive aspect of the real environment.

Accordingly, augmented reality may alter a user's current perception of a real world environment (as opposed to virtual reality that replaces the real world environment with a simulated one). One of the benefits of augmented reality is that it allows components of the digital world to be brought into a person's perception of the real world through the integration of immersive sensations that are perceived as natural parts of an environment.

Currently, navigating the world of augmented reality is a disjointed and complex task. For example, are their augmented reality rights associated with the Statue of Liberty? If so, who owns them? And can you (as a third party) obtain those rights? If so, how? And (assuming that you can obtain those rights), how do you associate content with (in this example) the Statue of Liberty?

### SUMMARY OF DISCLOSURE

In one implementation, a computer-implemented method is executed on a computing device and includes defining a plurality of augmented reality objects. Ownership rights are associated with one or more of the plurality of augmented reality objects. A user is enabled to query the plurality of augmented reality objects within an accessible virtual space to identify a specific augmented reality object.

One or more of the following features may be included. A user may be enabled to obtain ownership rights in the specific augmented reality object. Enabling a user to obtain ownership rights in the specific augmented reality object may include one or more of: enabling a user to obtain a license to the specific augmented reality object; and enabling a user to obtain an assignment to the specific augmented reality object. A user may be enabled to associate digital content with the specific augmented reality object. Enabling a user to associate digital content with the specific augmented reality object may include enabling a user to upload digital content for association with the specific augmented reality object. The accessible virtual space may be configured to interface with third-party applications to enable the association of the digital content with the specific augmented reality object. The plurality of augmented reality objects may include one or more of: a physical object; a group of physical object; a virtual object; and a group of virtual objects.

In another implementation, a computer program product resides on a computer readable medium and has a plurality of instructions stored on it. When executed by a processor, the instructions cause the processor to perform operations including defining a plurality of augmented reality objects. Ownership rights are associated with one or more of the plurality of augmented reality objects. A user is enabled to query the plurality of augmented reality objects within an accessible virtual space to identify a specific augmented reality object.

One or more of the following features may be included. A user may be enabled to obtain ownership rights in the specific augmented reality object. Enabling a user to obtain ownership rights in the specific augmented reality object may include one or more of: enabling a user to obtain a license to the specific augmented reality object; and enabling a user to obtain an assignment to the specific augmented reality object. A user may be enabled to associate digital content with the specific augmented reality object. Enabling a user to associate digital content with the specific augmented reality object may include enabling a user to upload digital content for association with the specific augmented reality object. The accessible virtual space may be configured to interface with third-party applications to enable the association of the digital content with the specific augmented reality object. The plurality of augmented reality objects may include one or more of: a physical object; a group of physical object; a virtual object; and a group of virtual objects.

In another implementation, a computing system includes a processor and memory is configured to perform operations including defining a plurality of augmented reality objects. Ownership rights are associated with one or more of the plurality of augmented reality objects. A user is enabled to query the plurality of augmented reality objects within an accessible virtual space to identify a specific augmented reality object.

One or more of the following features may be included. A user may be enabled to obtain ownership rights in the specific augmented reality object. Enabling a user to obtain ownership rights in the specific augmented reality object may include one or more of: enabling a user to obtain a license to the specific augmented reality object; and enabling a user to obtain an assignment to the specific augmented reality object. A user may be enabled to associate digital content with the specific augmented reality object. Enabling a user to associate digital content with the specific augmented reality object may include enabling a user to upload digital content for association with the specific augmented reality object. The accessible virtual space may be configured to interface with third-party applications to enable the association of the digital content with the specific augmented reality object. The plurality of augmented reality objects may include one or more of: a physical object; a group of physical object; a virtual object; and a group of virtual objects.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an augmented reality platform process according to an embodiment of the present disclosure;

FIG. 2 is a flowchart of the augmented reality platform process of FIG. 1 according to an embodiment of the present disclosure;

FIG. 3 is a diagrammatic view of an augmented reality advertisement; and

FIGS. 4-5 are diagrammatic views of windows rendered by the augmented reality platform process of FIG. 1.

Like reference symbols in the various drawings indicate like elements.

### DETAILED DESCRIPTION OF THE PREFERRED EMBODIMENTS

System Overview

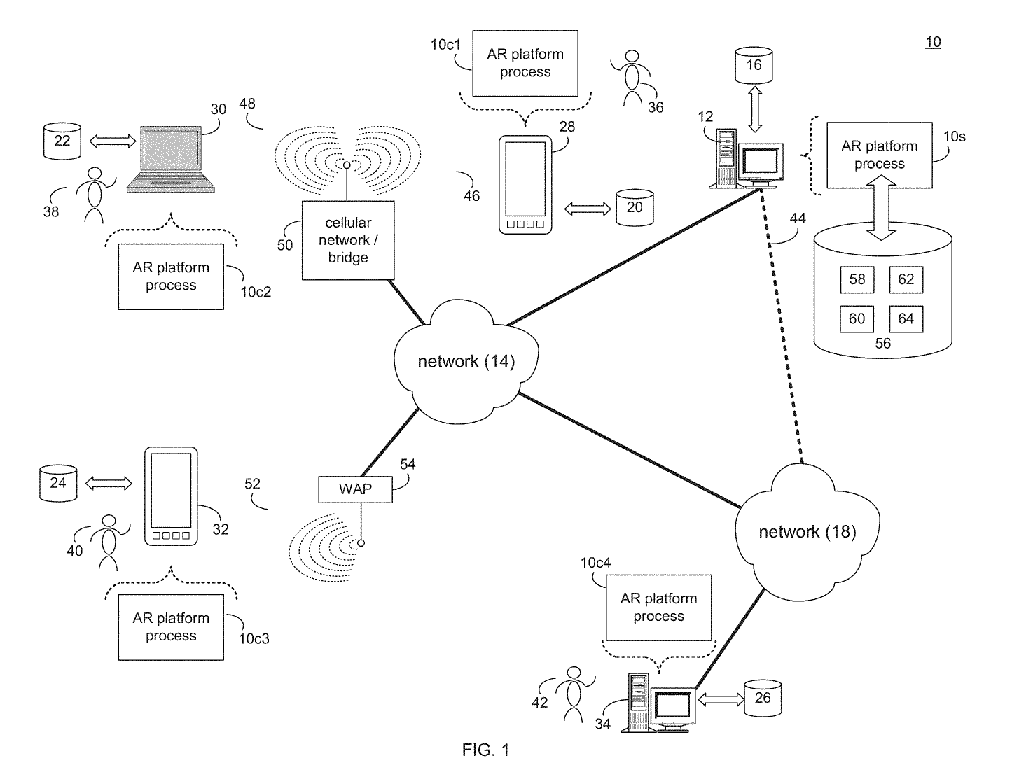

Referring to FIG. 1, there is shown augmented reality platform process 10. Augmented reality platform process 10 may be implemented as a server-side process, a client-side process, or a hybrid server-side/client-side process. For example, augmented reality platform process 10 may be implemented as a purely server-side process via augmented reality platform process 10s. Alternatively, augmented reality platform process 10 may be implemented as a purely client-side process via one or more of client-side process 10c1, client-side process 10c2, client-side process 10c3, and client-side process 10c4. Alternatively still, augmented reality platform process 10 may be implemented as a hybrid server-side/client-side process via data process 10s in combination with one or more of client-side process 10c1, client-side process 10c2, client-side process 10c3, and client-side process 10c4. Accordingly, augmented reality platform process 10 as used in this disclosure may include any combination of augmented reality platform process 10s, client-side process 10c1, client-side process 10c2, client-side process 10c3, and client-side process 10c4.

Augmented reality platform process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of augmented reality platform process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side processes 10c1, 10c2, 10c3, 10c4 may include but are not limited to a web browser, a user interface, or a specialized application (e.g., an application running on e.g., the Android™ platform or the iOS™ platform). The instruction sets and subroutines of client-side applications 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage device 16 may include but are not limited to: a hard disk drive; a RAID device; a random access memory (RAM); a read-only memory (ROM); and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a tablet computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access augmented reality platform process 10 directly through network 14 or through secondary network 18. Further, augmented reality platform process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Augmented Reality Platform

As discussed above, navigating the world of augmented reality is a disjointed and complex task. For example, are their augmented reality rights associated with the Statue of Liberty? If so, who owns them? And can you (as a third party) obtain those rights? If so, how? And (assuming that you can obtain those rights), how do you associate content with (in this example) the Statue of Liberty?

Quite differently, if you want to obtain the rights to the domain name Statue_of_Liberty.com, you can go to a publically-accessible portal (such as GoDaddy.com) and search for Statue_of_Liberty.com. Through such a portal, you can typically identify the status of Statue_of_Liberty.com (whether or not it is a registered domain name). And if it is a registered domain name, you can typically identify who owns Statue_of_Liberty.com. Such portals may identify the owner so that you may directly communicate with them. Alternatively, such portals may effectuate communication with the owner. Either of these actions with respect to contacting the owner may result in you being able to obtain rights to the domain name (via an assignment) or license rights to the domain name (via a license). Unfortunately, such a system is current unavailable in the augmented reality space.

Accordingly, augmented reality platform process 10 may be configured to allow for a user to navigate the world of augmented reality rights in a fashion similar to the above-described manner in which a user may navigate the world of domain name rights.

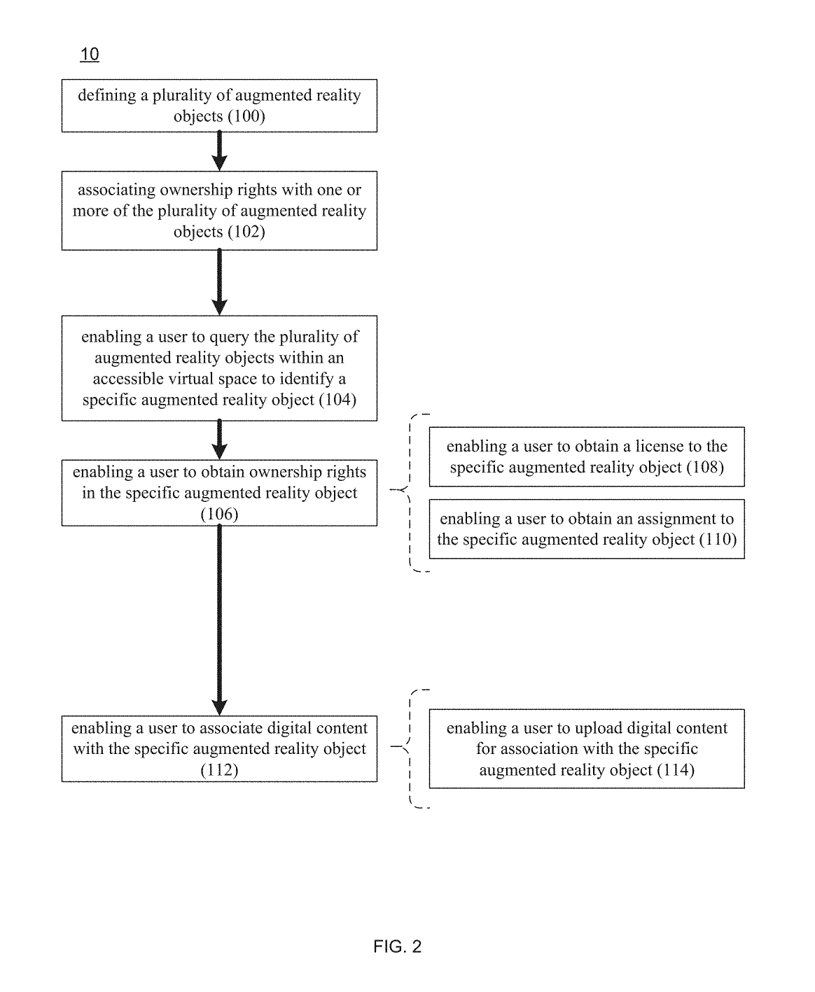

Referring also to FIG. 2, augmented reality platform process 10 may define 100 a plurality of augmented reality objects. Examples of such augmented reality objects may include but are not limited to one or more of: a physical object; a group of physical object; a virtual object; and a group of virtual objects.

For example and with respect to augmented reality objects that are physical objects, examples of such physical objects may include but are not limited to: the Eiffel Tower (in Paris, France), the Arc de Triomphe (in Paris, France), the Palace of Versailles (in Versailles, France), the Millau Viaduct (in Millau, France), the Abbey of Fontenay (in Marmagne, France), Notre Dame de Paris (in Paris, France), Pont du Gard (in Vers-Pont-du-Gard, France), Mont Blanc (in Chamonix, France), the Ponte Vecchio (in Florence, Italy), and the Colosseum (in Rome, Italy).

With respect to the augmented reality objects that are groups of physical objects, examples of such groups may include but are not limited to: Landmarks of Paris (which may include the Eiffel Tower, the Arc de Triomphe, and Notre Dame de Paris); Landmarks of France (which may include the Eiffel Tower, the Arc de Triomphe, the Palace of Versailles, the Millau Viaduct, the Abbey of Fontenay, Notre Dame de Paris, Pont du Gard, and Mont Blanc); and Landmarks of Europe (which may include the Eiffel Tower, the Arc de Triomphe, the Palace of Versailles, the Millau Viaduct, the Abbey of Fontenay, Notre Dame de Paris, Pont du Gard, Mont Blanc, the Ponte Vecchio and the Colosseum).

Concerning the augmented reality objects that are virtual objects, examples of such virtual objects may include but are not limited to a virtual object (e.g., an existing augmented reality object) that was previously associated with e.g., one or more of the above-described physical objects (e.g., the Eiffel Tower, the Arc de Triomphe, the Palace of Versailles, the Millau Viaduct, the Abbey of Fontenay, Notre Dame de Paris, Pont du Gard, Mont Blanc, the Ponte Vecchio and the Colosseum).

And concerning the augmented reality objects that are groups of virtual objects, examples of such groups of virtual objects may include but are not limited to groups of virtual objects (e.g., groups of existing augmented reality objects) that were previously associated with e.g., one or more of the above-described physical objects (e.g., the Eiffel Tower, the Arc de Triomphe, the Palace of Versailles, the Millau Viaduct, the Abbey of Fontenay, Notre Dame de Paris, Pont du Gard, Mont Blanc, the Ponte Vecchio and the Colosseum).

Accordingly, augmented reality platform process 10 may be configured to define 100 (within e.g., AR object database 56) a plurality of augmented reality objects (e.g., AR objects 58, 60, 62, 64). Further, augmented reality platform process 10 may associate 102 ownership rights with one or more of the plurality of augmented reality objects (e.g., AR objects 58, 60, 62, 64) and may enable 104 a user to query the plurality of augmented reality objects (e.g., AR objects 58, 60, 62, 64) within an accessible virtual space (e.g., a website such as www.AugmentedRealityMarketplace.com) to identify a specific augmented reality object.

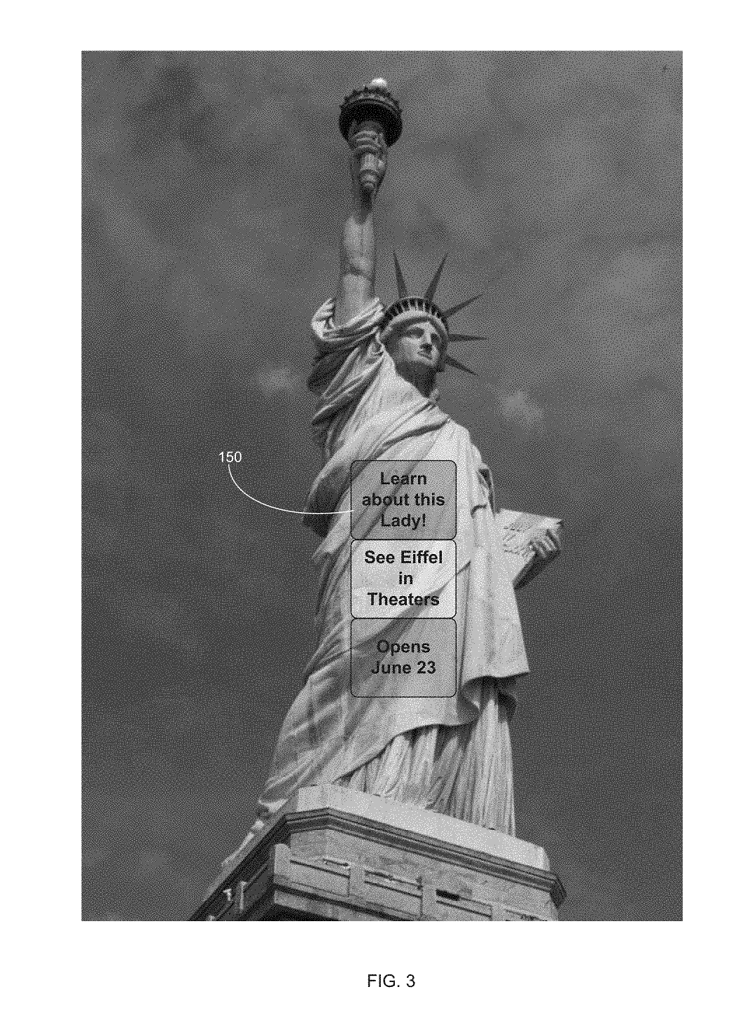

For example, assume that a biographical movie named “Eiffel” is going to be released in the coming year on the life and times of Gustave Eiffel, the civil engineer who designed the Eiffel Tower in Paris and who built the Statue of Liberty in New York Harbor. Further assume that user 36 works for an US advertising company (e.g., ABC Advertising) that was hired to promote “Eiffel”. Accordingly, user 36 may like to utilize an augmented reality advertising campaign in which augmented reality advertisements are positioned on the surface of the Statue of Liberty. Accordingly, if someone views the Statue of Liberty through an augmented reality device (e.g., Microsoft HoloLens™, Magic Leap Lightwear™, Epson Moverio™, Google Glass™, and any handheld electronic device (such as an iPhone™ or an Android™ phone) executing an augmented reality application (such as Pokemon Go™), they will see an augmented reality advertising campaign. For example and referring also to FIG. 3, there is shown one illustrative example of the manner in which augmented reality advertisements 150 may be positioned on the surface of the Statue of Liberty.

Continuing with the above-stated example, assume that augmented reality platform process 10 defines 100 (within e.g., AR object database 56) AR object 58 for the Statue of Liberty. Further, assume that augmented reality platform process 10 associates 102 the ownership rights of the Statue of Liberty (as represented by AR object 58) with the National Park Service. So continuing with the above-stated example in which user 36 wishes to utilize an augmented reality advertising campaign in which augmented reality advertisements 150 are positioned on the surface of the Statue of Liberty, user 36 may need to determine who (if anyone) has ownership rights with respect to AR object 58 (i.e., the Statue of Liberty).

As discussed above, augmented reality platform process 10 may enable 104 user 36 to query the plurality of augmented reality objects (e.g., AR objects 58, 60, 62, 64) defined within AR object database 56 to determine who (if anyone) has ownership rights with respect to AR object 58 (i.e., the Statue of Liberty). Assume for illustrative purposes that, upon executing the above-described query, augmented reality platform process 10 informs user 36 that the “National Park Service” owns the augmented reality rights associated with AR object 58. In the event that no entity was identified as owning the augmented reality rights associated with AR object 58, user 36 may be informed of the same.

In the event that the user (e.g., user 36) is interested in obtaining ownership rights, augmented reality platform process 10 may enable 106 a user (e.g., user 36) to obtain such ownership rights in a specific augmented reality object (e.g., AR object 58). Therefore, if user 36 is informed by augmented reality platform process 10 that the “National Park Service” has ownership interests in AR object 58, augmented reality platform process 10 may enable 106 user 36 to obtain such ownership rights in AR object 58 from the “National Park Service”.

When enabling 106 user 36 to obtain ownership rights in the specific augmented reality object (e.g., AR object 58), augmented reality platform process 10 may simply provide the name and/or contact information of the current owner (e.g., the National Park Service) of AR object 58. In such a configuration, user 36 may then initiate contact with (in this example) the National Park Service so that they may obtain the desired ownership interest in AR object 58.

Further and when enabling 106 user 36 to obtain ownership rights in the specific augmented reality object (e.g., AR object 58), augmented reality platform process 10 may enable 108 user 36 to obtain a license to AR object 58 or may enable 110 user 36 to obtain an assignment to AR object 58. As is known in the art, an assignment is a legal term used in the context of contract law, wherein the owner of an interest (the assignor) transfers the ownership rights in e.g., AR object 58 to a third party (the assignee). Further and as is known in the art, a license is a legal term used in the context of contract law, wherein the owner of an interest (the licensor) grants permission in e.g., AR object 58 to a third party (the licensee).

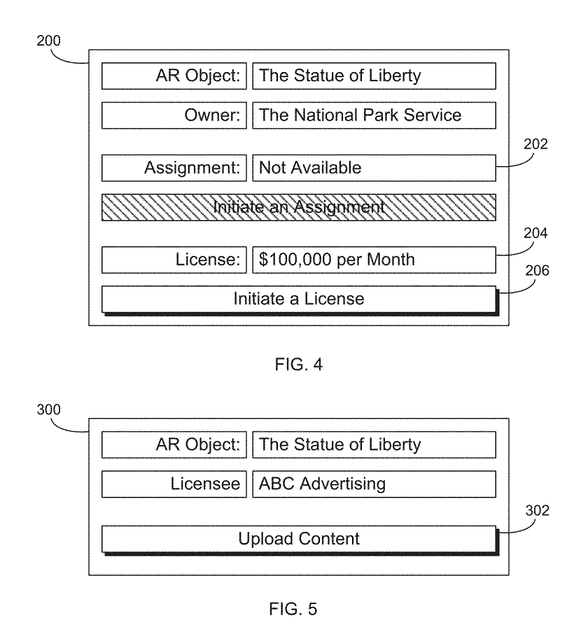

Through the use of augmented reality platform process 10, user 36 may obtain a license or assignment of AR object 58 (assuming that the owner of AR object 58 is willing to grant such a license or assignment). For example and referring also to FIG. 4, user 36 may query the plurality of augmented reality objects (e.g., AR objects 58, 60, 62, 64) defined within AR object database 56 to determine who (if anyone) has ownership rights with respect to AR object 58 (i.e., the Statue of Liberty). In response to such a query, augmented reality platform process 10 may render window 200 on a display screen of client electronic device 28 informing user 36 that the National Park Service has ownership rights in AR object 58 (i.e., the Statue of Liberty).

As discussed above, augmented reality platform process 10 may enable 108 user 36 to obtain a license to AR object 58 and/or may enable 110 user 36 to obtain an assignment to AR object 58. For example, augmented reality platform process 10 may identify whether an assignment is available (via field 202) and may identify whether a license is available (via field 204). In this example, field 202 within window 200 is shown to identify an assignment as being unavailable, while field 204 within window 200 is shown to identify a license as being available for $100,000 per month. Assuming that user 36 wishes to obtain such a license, user 36 may select “Initiate a License” within field 206 to obtain such a license.

As shown in FIG. 5 and once (in this example) this license has been completed and user 36 is the licensee of AR object 58, augmented reality platform process 10 may render window 300 that identifies e.g., ABC Advertising as the licensee of AR Object 58. Augmented reality platform process 10 may enable 112 user 36 to associate digital content with the specific augmented reality object (e.g., AR object 58). For example and continuing with the above-stated example in which user 36 wishes to utilize an augmented reality advertising campaign in which augmented reality advertisements are positioned on the surface of the Statue of Liberty, user 36 may generate digital content (e.g., augmented reality advertisements 150). Accordingly and when enabling 112 user 36 to associate digital content (e.g., augmented reality advertisements 150) with the specific augmented reality object (e.g., AR object 58), augmented reality platform process 10 may enable 114 user 36 to upload digital content (e.g., augmented reality advertisements 150) for association with the specific augmented reality object (e.g., AR object 58). Additionally, the accessible virtual space (e.g., a website) through which user 36 may be accessing and utilizing augmented reality platform process 10 may be configured to interface with third-party applications (e.g., an AR content production platform; not shown) to enable the association of the digital content (e.g., augmented reality advertisements 150) with the specific augmented reality object (e.g., AR object 58).

When associating digital content (e.g., augmented reality advertisements 150) with a specific augmented reality object (e.g., AR object 58), various digital content-to-AR object mapping methodologies may be employed to ensure that the associations are proper, clear and lack ambiguity. As shown in FIG. 2, AR object 58 (i.e., the Statue of Liberty) is a three-dimensional object. Accordingly, digital content (e.g., augmented reality advertisements 150) may be positioned on three-dimensional objects in a three-dimensional manner. For example, certain digital content (e.g., augmented reality advertisements 150) may be positioned to be shown on the front of AR object 58 (i.e., the front of the Statue of Liberty) while other digital content (not shown) may be positioned on the back of AR object 58 (i.e., the back of the Statue of Liberty). Accordingly and to obtain such high levels of positioning granularity, various methodologies may be employed.

For example, when digital content (e.g., augmented reality advertisements 150) is uploaded to augmented reality platform process 10, the intended location of the digital content (e.g., augmented reality advertisements 150) with respect to AR object 58 may be defined (via metadata) to be e.g., the front of the Statue of Liberty. Accordingly and in the event that augmented reality platform process 10 is configured to perform object recognition, in the event that a user of a augmented reality devices if viewing e.g., the front of the Statue of Liberty via an augmented reality device (e.g., Microsoft HoloLens™, Magic Leap Lightwear™, Epson Moverio™, Google Glass™, and any handheld electronic device (such as an iPhone™ or an Android™ phone) executing an augmented reality application (such as Pokemon Go™), the digital content (e.g., augmented reality advertisements 150) may be superimposed onto the front of the Statue of Liberty (as shown in FIG. 3).

In the event that augmented reality platform process 10 is not configured to perform object recognition, other digital content-to-AR object mapping methodologies may be employed. For example, the geographic location of the Statue of Liberty may be defined as 40° 41′21″N/74° 2′40″W and having a height of 305 feet. As is known in the art, when looking through an augmented reality device (e.g., Microsoft HoloLens™, Magic Leap Lightwear™, Epson Moverio™, Google Glass™, and any handheld electronic device (such as an iPhone™ or an Android™ phone) executing an augmented reality application (such as Pokemon Go™), the position of the wearer and the direction in which they are looking is known by the device. Accordingly, if they are positioned in the appropriate place and looking in the appropriate direction so that they would be looking at the front of the Statue of Liberty, the digital content (e.g., augmented reality advertisements 150) may be superimposed onto the front of the Statue of Liberty (as shown in FIG. 3).

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
defining a plurality of augmented reality objects;
associating ownership rights with one or more of the plurality of augmented reality objects; and
enabling a user to query the plurality of augmented reality objects within an accessible virtual space to identify a specific augmented reality object.

2. The computer-implemented method of claim 1 further comprising:
enabling a user to obtain ownership rights in the specific augmented reality object.

3. The computer-implemented method of claim 2 wherein enabling a user to obtain ownership rights in the specific augmented reality object includes one or more of:
enabling a user to obtain a license to the specific augmented reality object; and
enabling a user to obtain an assignment to the specific augmented reality object.

4. The computer-implemented method of claim 1 further comprising:
enabling a user to associate digital content with the specific augmented reality object.

5. The computer-implemented method of claim 4 wherein enabling a user to associate digital content with the specific augmented reality object includes:
enabling a user to upload digital content for association with the specific augmented reality object.

6. The computer-implemented method of claim 4 wherein the accessible virtual space is configured to interface with third-party applications to enable the association of the digital content with the specific augmented reality object.

7. The computer-implemented method of claim 1 wherein the plurality of augmented reality objects includes one or more of:
a physical object;
a group of physical object;
a virtual object; and
a group of virtual objects.

8. A computer program product residing on a computer readable medium having a plurality of instructions stored thereon which, when executed by a processor, cause the processor to perform operations comprising:
defining a plurality of augmented reality objects;
associating ownership rights with one or more of the plurality of augmented reality objects; and
enabling a user to query the plurality of augmented reality objects within an accessible virtual space to identify a specific augmented reality object.

9. The computer program product of claim 8 further comprising:
enabling a user to obtain ownership rights in the specific augmented reality object.

10. The computer program product of claim 9 wherein enabling a user to obtain ownership rights in the specific augmented reality object includes one or more of:
enabling a user to obtain a license to the specific augmented reality object; and
enabling a user to obtain an assignment to the specific augmented reality object.

11. The computer program product of claim 8 further comprising:
enabling a user to associate digital content with the specific augmented reality object.

12. The computer program product of claim 11 wherein enabling a user to associate digital content with the specific augmented reality object includes:
enabling a user to upload digital content for association with the specific augmented reality object.

13. The computer program product of claim 11 wherein the accessible virtual space is configured to interface with third-party applications to enable the association of the digital content with the specific augmented reality object.

14. The computer program product of claim 8 wherein the plurality of augmented reality objects includes one or more of:
a physical object;
a group of physical object;
a virtual object; and
a group of virtual objects.

15. A computing system including a processor and memory configured to perform operations comprising:
defining a plurality of augmented reality objects;
associating ownership rights with one or more of the plurality of augmented reality objects; and
enabling a user to query the plurality of augmented reality objects within an accessible virtual space to identify a specific augmented reality object.

16. The computing system of claim 15 further comprising:
enabling a user to obtain ownership rights in the specific augmented reality object.

17. The computing system of claim 16 wherein enabling a user to obtain ownership rights in the specific augmented reality object includes one or more of:
enabling a user to obtain a license to the specific augmented reality object; and
enabling a user to obtain an assignment to the specific augmented reality object.

18. The computing system of claim 15 further comprising:
enabling a user to associate digital content with the specific augmented reality object.

19. The computing system of claim 18 wherein enabling a user to associate digital content with the specific augmented reality object includes:
enabling a user to upload digital content for association with the specific augmented reality object.

20. The computing system of claim 18 wherein the accessible virtual space is configured to interface with third-party applications to enable the association of the digital content with the specific augmented reality object.

21. The computing system of claim 15 wherein the plurality of augmented reality objects includes one or more of:
a physical object;
a group of physical object;
a virtual object; and
a group of virtual objects.
